(19) United States
(12) Patent Application Publication
(10) Pub. No.: US 2009/0109126 A1
(43) Pub. Date: Apr. 30, 2009

(54) MULTIPLE VIEW DISPLAY SYSTEM

(76) Inventors: Heather Ann Stevenson, Leamington Spa (GB); Grant Bourhill, Gloucestershire (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 11/994,683

(22) PCT Filed: Jul. 7, 2006
(86) PCT No.: PCT/JP2006/314016

§ 371 Date: May 20, 2008

(30) Foreign Application Priority Data
Jul. 8, 2005 (GB) 0513970.4

(51) Int. Cl. G09G 5/00

(52) U.S. Cl. 345/4

(57) ABSTRACT

An interactive multiple view display system has a multiple view display which displays images of independently selectable content so as to make them visible in respective different viewing regions. A detection arrangement detects which of a plurality of users is attempting to interact with one of the displayed images. An interaction arrangement then permits the detected user to interact with the image.

### TECHNICAL FIELD

The present invention relates to multiple view display systems. Such systems may be used to display a plurality of independently selectable images (including sequences of images) in different viewing regions. Such systems may, for example be of the spatially multiplexed type (in which spatially multiplexed images are displayed simultaneously), of the temporary multiplexed or time-sequential type (in which different views are displayed in different time frames of a repeating cycle of time frames), or systems which employ mixtures of these techniques (for example displaying different spatially multiplexed views in the time frames of a repeating cycle or sequence).

Although such display systems may display any desired number of images effectively simultaneously for simultaneous viewing by viewers or users in the viewing regions, the commonest type of display system of this type displays two views and is referred to as a dual view display or display system. Such systems include some form of display and examples of types of displays which may be used include liquid crystal displays (LCDs), cathode ray tubes (CRTs), organic light emitting devices (OLEDs), light emitting diodes (LEDs) and plasma display panels (PDPs). Such displays or display systems may also be switchable from a dual or multiple view mode of operation to a single view mode, in which a single view or image is displayed for viewing throughout a relatively large viewing region.

### BACKGROUND ART

GB2405542 discloses techniques which allow a parallax barrier to be placed sufficiently close to the pixels of an LCD to allow a dual view display with good image quality to be made.

GB2405516 discloses a display which displays two images from one uniform panel by the use of LC modes, in some cases together with a parallax barrier to produce a dual view display.

GB2405489 discloses the use of a mirror with a dual view display to increase the apparent screen size of the dual view display.

Willem den Boer et al. (SID 03 DIGEST 56.3) describe a display with integrated optical sensors at each pixel. This device allows multiple users to operate the touch panel simultaneously by imaging the shadow formed by a finger. However this method requires a high degree of data processing to detect the touches and further, cannot identify which user generated each touch.

WO 2005/021314 A1 discloses a method of controlling the display of different information in a vehicle and optoacoustic information unit. A system is provided which detects the driver's gaze and, when the driver is looking at the display, it updates to show only journey related information. When the driver is not looking at the display, non-journey related information may be displayed. If the passenger was trying to view a film, there would be continual interruptions which would detract from the appeal of the system.

U.S. Pat. No. 1,150,374 discloses a “changeable picture” comprising “fixed” (e.g. printed) spatially interlaced images behind a lenticular array. When a user moves his or her head horizontally, the image changes, for example so as to simulate movement.

### DISCLOSURE OF INVENTION

According to a first aspect of the invention, there is provided an interactive multiple view display system comprising: a multiple view display arranged to display images of independently selectable content which are visible in respective different viewing regions; a detection arrangement arranged to detect which of a plurality of users is attempting to interact with at least one of the images by detecting the location or direction with respect to the display of the or each detected user from the depth and/or duration of a shadow cast by the or each user on the display, and an interaction arrangement arranged to permit the or each detected user to interact with the or a respective one of the at least one image.

The detection arrangement may be arranged to detect which of the users are simultaneously attempting to interact with the images. The interaction arrangement may be arranged to permit the users to interact simultaneously with respective ones of the images.

The detection arrangement may comprise a light sensing arrangement attached to or forming part of the display.

According to a second aspect of the invention, there is provided an interactive multiple view display system comprising: a multiple view display arranged to display images of independently selectable content which are visible in respective different viewing regions; a detection arrangement arranged to detect which of a plurality of users is attempting to interact with at least one of the images and comprising a voice recognition system for determining the identity of the or each detected user; and an interaction arrangement arranged to permit the or each detected user to interact with the or a respective one of the at least one image.

The interaction arrangement may comprise a touchscreen forming part of the display and an image generator for generating as at least one of the images an image representing user-operable controls. The image generator may be arranged to generate an image of a keyboard or key pad.

The system may have an alternative single view mode of operation which is selectable by at least one user.

According to a third aspect of the invention, there is provided a multiple view display system comprising a fixed-location multiple view display arranged to display images of independently selectable content which are visible in viewing regions at respective different heights with respect to and/or distances from the display and a mirror for increasing the display area in a viewing region nearest the display.

The system may comprise an image generator for supplying to the display image data representing at least one image whose content is relevant to and/or determined by location of the viewing region in which the at least one image is visible.

According to a fourth aspect of the invention, there is provided a multiple view display system disposed adjacent a user-operable apparatus, comprising a fixed-location multiple view display arranged to display images of independently selectable content which are visible in viewing regions at respective different heights with respect to and/or distances from the display, and an image generator for supplying to the display image data representing at least one image whose content is relevant to and/or determined by location of the viewing region in which the at least one image is visible, the image generator being arranged to supply to the display, for display in a viewing region adjacent the apparatus, image data representing information for user-interaction with the apparatus.

According to a fifth aspect of the invention, there is provided a multiple view display system comprising a fixed-location multiple view display arranged to display images of independently selectable content which are visible in viewing regions at respective different heights with respect to and/or distances from the display, and an image generator for supplying to the display image data representing at least one image whose content is relevant to and/or determined by location of the viewing region in which the at least one image is visible, the image generator being arranged to supply to the display, for display in a viewing region above a predetermined height, image data representing an entry code for permitting entry to a restricted area.

The display may be arranged to generate asymmetric viewing windows.

According to a sixth aspect of the invention, there is provided a multiple view display system comprising: a multiple view display arranged to display images of independently selectable content which are visible in respective difference viewing regions; and an image generator for supplying to the display image data representing different views of the same subject for display as different images.

The different views may comprise at least one overlay view.

The different views may comprise images captured in different parts of the electromagnetic spectrum.

According to a seventh aspect of the invention, there is provided an interactive multiple view display system comprising: a multiple view display arranged to display images of independently selectable content which are visible in respective different viewing regions; an image generator for supplying to the display image data representing different images including a graphical user interface which is visible in at least one of the viewing regions and is not visible in at least one other of the viewing regions; and a detection arrangement for detecting user interaction with the graphical user interface, the image generator being arranged to supply image data representing an image or image sequence to be visible in the at least one other viewing region and the same image or image sequence overlaid by the graphical user interface to be visible in the at least one viewing region.

The system may form part of an apparatus arranged to respond to detected user interaction.

According to an eighth aspect of the invention, there is provided a multiple view display system comprising: a multiple view display arranged to display images of independently selectable content which are visible in respective different viewing regions; a tracking arrangement for determining at least one point on the display at which at least one user is looking; and an enhancing arrangement for enhancing image display at the least one point, relative to a surrounding region of the display, at least of the image visible to the at least one user.

### BRIEF DESCRIPTION OF DRAWINGS

FIG. 1(a) is diagrammatic plan view of a dual view display-used for translation;

FIG. 1(b) is a diagrammatic side view of the display of FIG. 1(a);

FIG. 2(a) is a diagrammatic side view of another dual view display used for translation;

FIG. 2(b) is a diagrammatic side view illustrating another orientation of the display of FIG. 2(a);

FIG. 3 is a diagrammatic plan view illustrating a multiple view display used to provide motorway information;

FIG. 4 is a diagrammatic plan view of a dual view display for providing arrival and departure information;

FIG. 5 is a diagrammatic plan view of a display for providing different advertising information in different directions;

FIG. 6 is a diagram illustrating a dual view display for use in presentations;

FIG. 7 is a diagram illustrating a multiple view display for displaying emergency service text;

FIGS. 8(a) to 8(c) are diagrams illustrating a dual view display for providing in-car navigation information.

FIG. 9 is a diagram illustrating a dual view display for educational use;

FIG. 10 is a diagram illustrating a multiple view display for use in mobile devices;

FIG. 11 is a diagram illustrating a multiple view display for use in karaoke;

FIG. 12 is a diagram illustrating a multiple view display for use in an aeroplane for in-flight entertainment;

FIG. 13 is a diagram illustrating a dual view display for simultaneously displaying adult and child-friendly versions of a programme;

FIG. 14(a) is a diagram illustrating a multiple view display for use in a cricket stadium;

FIG. 14(b) is a diagram illustrating a multiple view display for use in a football stadium;

FIG. 15(a) is a diagram illustrating a dual view display forming part of a portable DVD player;

FIG. 15(b) illustrates a different orientation of the display of FIG. 15(a);

FIG. 16 is a diagram illustrating a dual view display for use in privacy or security applications;

FIG. 17 is a diagram illustrating a dual view display for displaying a virtual keyboard;

FIG. 18(a) is a diagram illustrating a dual view display with remote control interaction for use in a car;

FIG. 18(b) is a diagram illustrating a first example of a directional detector system for use in the display of FIG. 18(a);

FIG. 18(c) is a diagram illustrating a second example of a directional detector system for use in the display of FIG. 18(a);

FIG. 19 is a diagram illustrating a dual view display which is capable of determining which user is trying to interact with the display;

FIG. 20 is a diagram illustrating an example of the display of FIG. 19;

FIG. 21(a) is a diagram illustrating another example of the display of FIG. 19;

FIG. 21(b) is a diagram illustrating a detail of the example of FIG. 21(a);

FIG. 22 is a diagram illustrating a dual view display providing angular/height image segregation;

FIG. 23 is a diagram illustrating an application of the display of FIG. 22;

FIG. 24 is a diagram illustrating another dual view display for providing angular/height image segregation;

FIG. 25 is a diagram illustrating a dual view projection display for use in presentations;

FIG. 26 is a schematic diagram illustrating a system for detecting the direction of touch on a dual view display;

FIG. 27 is a schematic diagram illustrating a voice recognition technique incorporated into a multiple view display;

FIG. 28 is a schematic diagram illustrating a system for tracking gaze direction in a multiple view display; and

FIG. 29 is a schematic diagram illustrating an image generator of a multiple view display.

Like reference numerals refer to like parts throughout the drawings.

### BEST MODE FOR CARRYING OUT THE INVENTION

### 1. Translation

(a) Japanese-English dictionary:

Known electronic dictionaries are only suitable for use by one user at a time, for example for converting Japanese to English.

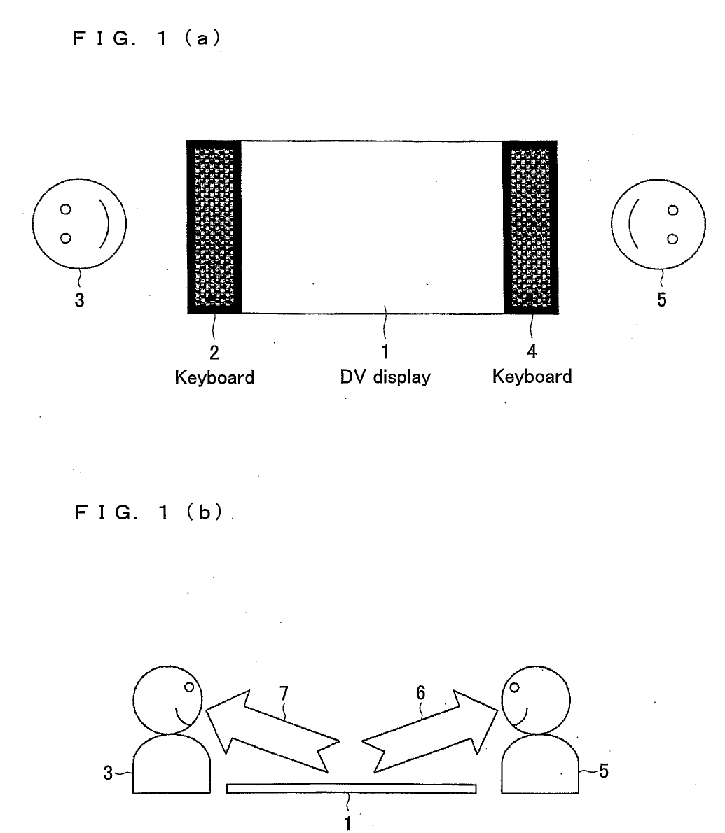

FIGS. 1(a) and 1(b) show a face to face system where both users may simultaneously view the translation, each user only seeing their own language. The particular example shown in FIGS. 1(a) and 1(b) comprises a dual view (DV) display 1 provided with a keyboard 2 for a Japanese user 3 and a keyboard 4 for an English user 5. The display 1 displays an image containing an “English view” of English-language text in a viewing direction 6 for the English user 5. The display 1 also provides a “Japanese view” of Japanese-language text in a viewing direction 7 for the Japanese user 3. The translation may be carried out by the users entering data via the keyboard 2, 4 or a mouse, or by other means such as by voice recognition. This may be extended to multi-user systems across multiple languages with multiple views being presented.

Alternatively the translation may be carried out in non-face to face situations, such as across the internet or via video conferencing where users of multiple languages are present in the same room.

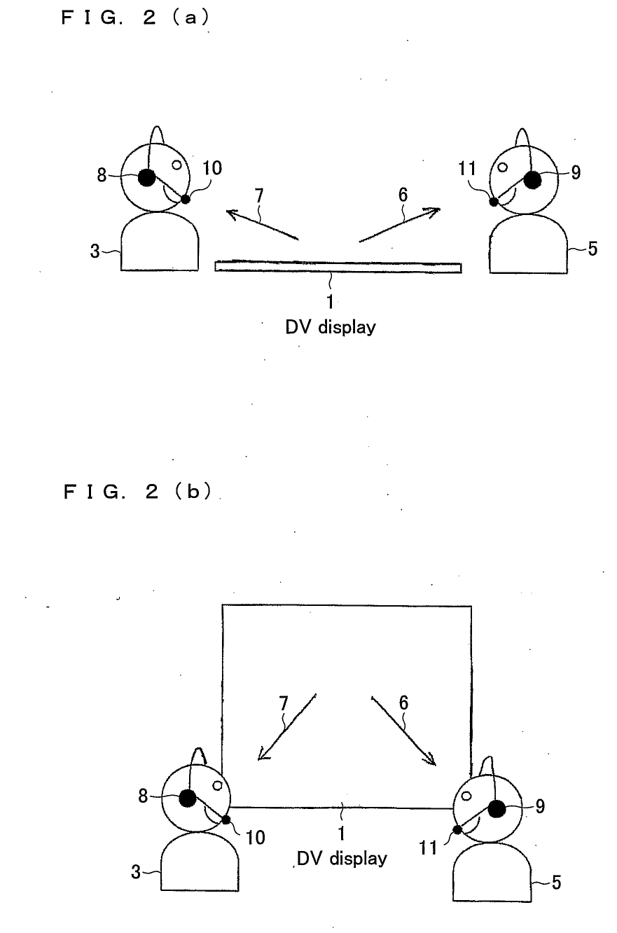

As shown in FIGS. 2(a) and 2(b), the translation may be simultaneously viewable by each person in their own language on the dual view display 1 and audible via a suitable headphones arrangement 8, 9. This may be particularly beneficial where translations of documents such as PowerPoint presentations are being displayed to each user and additionally a spoken, translated conversation is being carried out between the users by means of microphones 10, 11 for inputting into a translation system.

### 2. Displaying Information

(a) Multiple view for motorway information

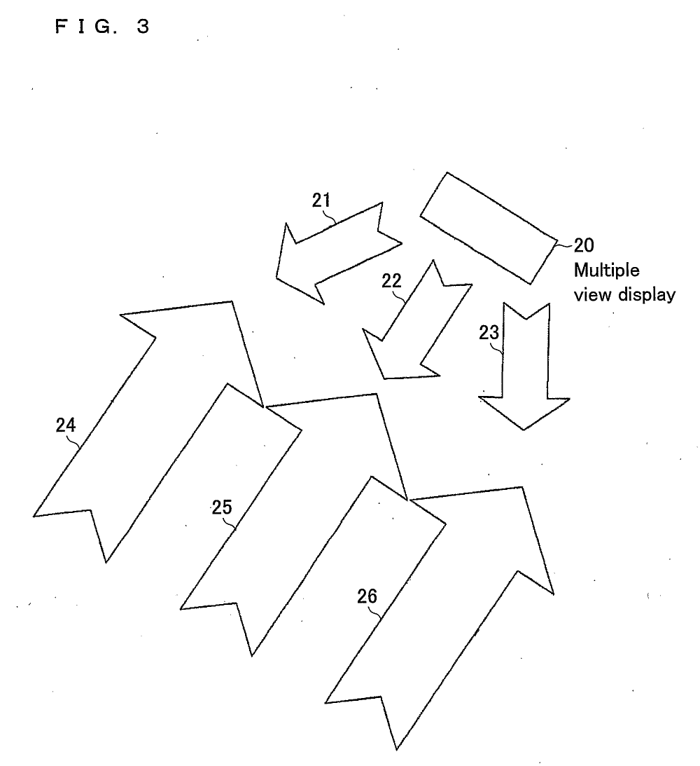

A multiple view display 20 may be used for motorway information signage by presenting a different view to the traffic in each of the lanes. It may be mounted above the centre of the motorway, which is illustrated in FIG. 3, or it may be mounted off to one side. Information for the left hand, middle and right hand motorway lanes 21, 22, 23 is directed by the display 20 in the directions 24, 25 and 26, respectively.

(b) Dual view for information boards such as airport and train arrivals/departures:

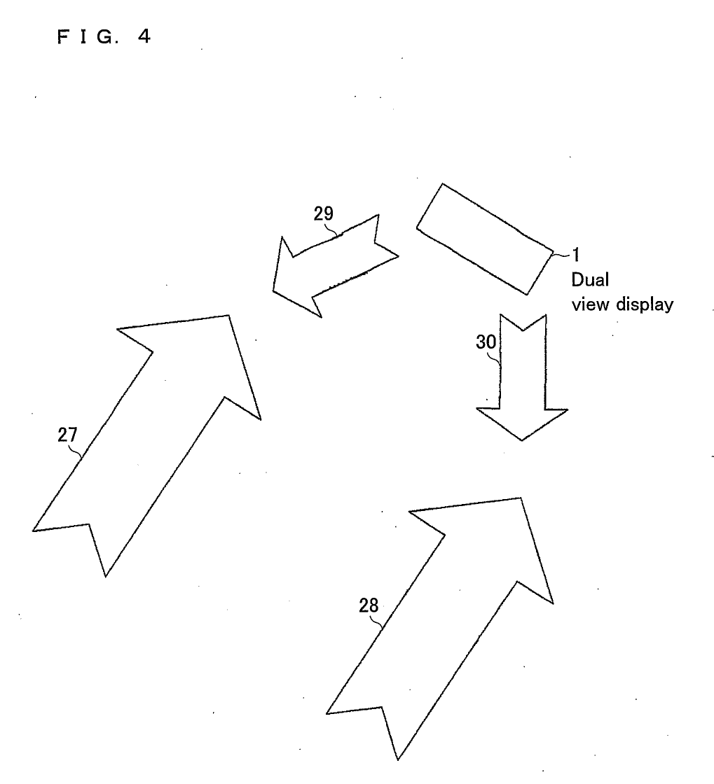

A dual view display 1 may be used for information boards such as airport and train arrivals/departures by presenting a different view to passengers as they move below the display. For example, it may be mounted above the centre of an island railway platform, having areas 27 and 28 for passengers for trains using different tracks, as illustrated in FIG. 4. As passengers move from one side of the platform to the other, they see only the information for the relevant platform directed in directions 29 and 30. Also, the display may be mounted off to one side.

(c) Dual view for advertising:

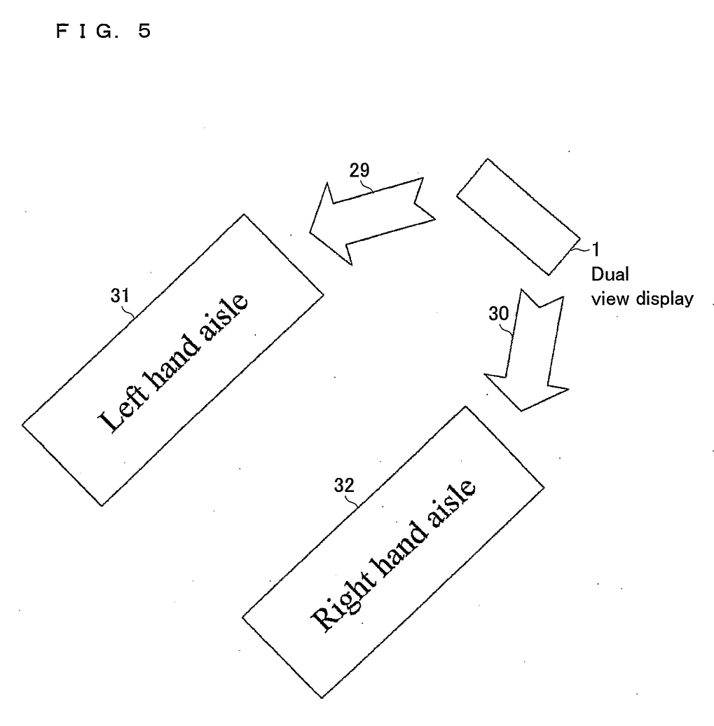

A dual view display 1 may be used for advertising purposes. Different adverts may be displayed in different directions from one display. This allows more adverts to be displayed from one display hence resulting in lower costs. This is illustrated in FIG. 5, where the advert for the left hand aisle 31 is displayed to the left hand side 29 and the advert for the right hand aisle 32 is displayed to the right hand side 30. This also allows adverts or special offers specific to the products in that direction to be displayed. Alternatively, a series of different adverts may be displayed from one dual view display to the traffic as it moves past if the dual view display is mounted parallel to the direction of travel.

(d) Dual view for presentations:

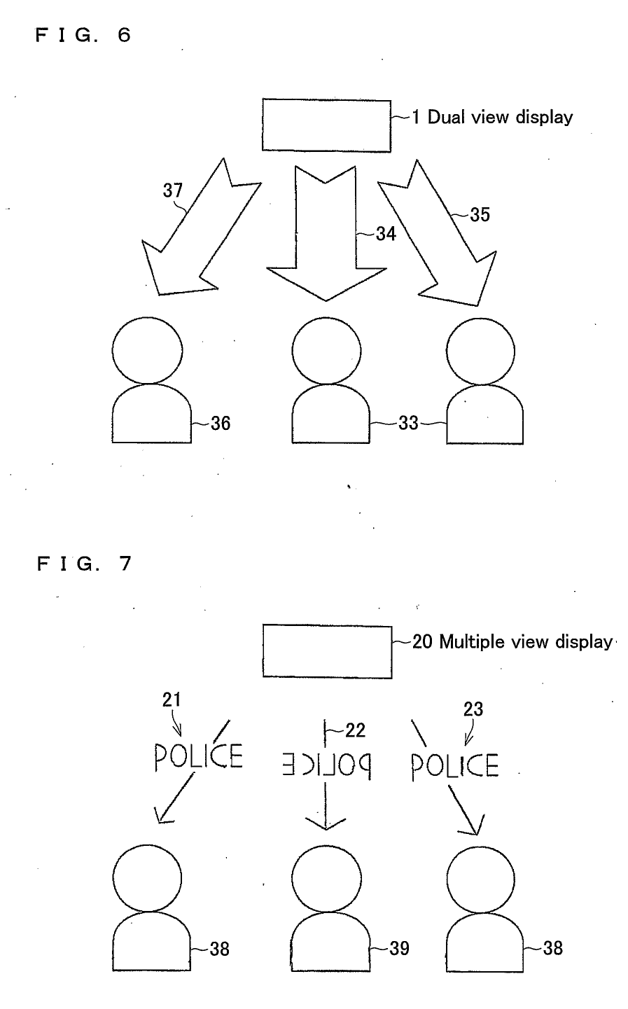

A dual view display 1 may be used for presenting information such as PowerPoint presentations. It allows one view to display the presentation to the audience 33, for example in directions 34 and 35, and a second view to display notes on the presentation to the presenter 36 in the direction 37. This is illustrated in FIG. 6.

(e) Three view emergency service text display:

A multiple view display 20 may be used to aid the emergency services in their speed of recognition by other road users. Off axis, as shown at 21 and 23, the display shows the correct text, for example the word “POLICE”, for pedestrians 38 who will directly be viewing the notice. In the on axis region, as shown at 22, the display shows reversed text for easy reading by drivers 39 using their rear view mirrors. This is illustrated in FIG. 7.

(f) In car navigation:

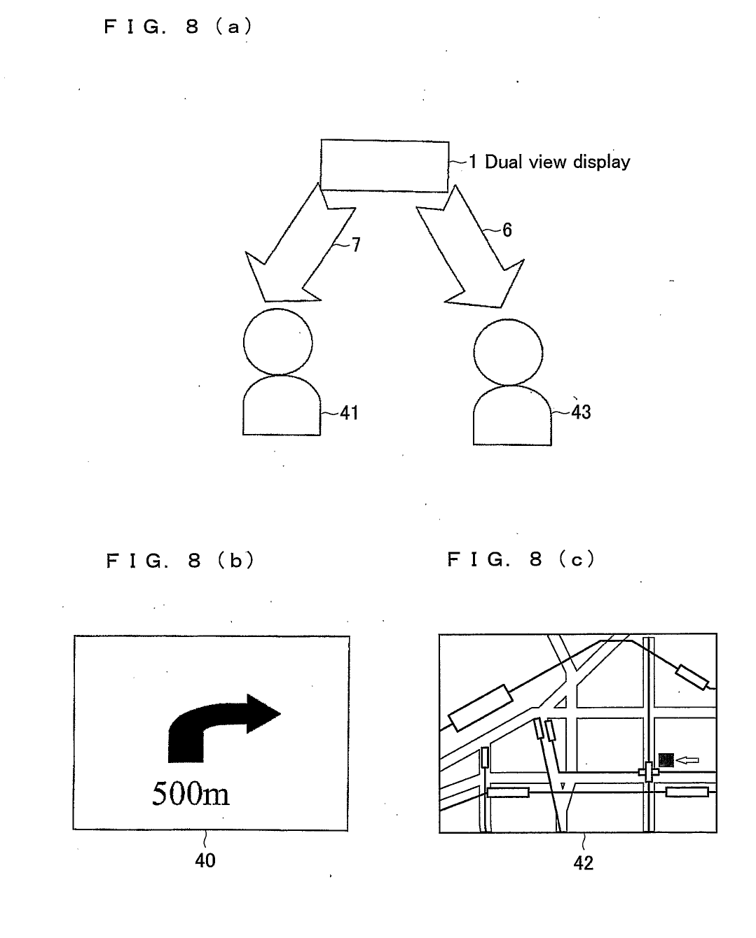

A dual view display 1 may be used with an in car navigation system. The driver's view 40 is directed towards a driver 41 and shows only basic simple information. The passenger's view 42 is directed towards a passenger 43 and shows far more detailed information. This is illustrated in FIG. 8.

(g) Education:

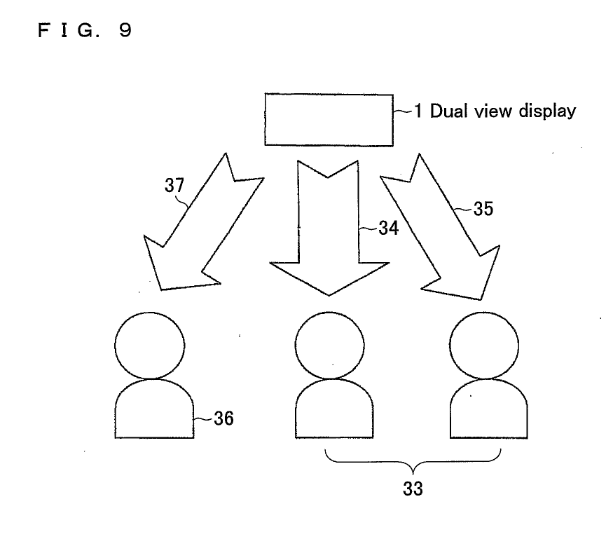

A dual view display 1 may be used for educational purposes. For example, one view may be presented to the student or students 33 displaying the questions in directions 34 and 35 and another view may be presented to the teacher 36 displaying the questions and answers in the direction 37. This is illustrated in FIG. 9.

(h) Use with X-ray/security:

A dual view display may be used for security applications, for example in conjunction with an x-ray scanner. One view displays the x-ray or security image to a security guard and the other view displays a second image to the people passing through the security check. This might be an advertising image or airport information.

(i) Medical:

A dual view display may be used for medical applications. For example, one view is presented to a surgeon who sees a magnified view of the operation and another view shows other medical information such as blood pressure and/or heart monitoring for use by another member of the medical team.

(j) Signs depending on entry/exit:

A dual view display may be used for entry/exit signs. This may be particularly advantageous for shops or restaurants. As you enter the building, you see a first view displaying a welcome message and as you exit the building, you see a second view displaying a suitable leaving message. This may also be used to show a warning message when the user tries to exit through an entry only door.

(k) Cockpit displays:

A dual view display may be used in a cockpit. One camera's view is presented to a particular pilot and another view to another pilot presents alternative information. Alternatively, in small planes, one view may be presented to the pilot another to a passenger.

(l) Overlay:

A dual view display may be used to present an original image in one view and an overlay image in another view or views. This may be particularly advantageous for example in CAD (computer aided design) designs where registration of overlayed images is important and being able to move easily from view to view containing different overlays simplifies the process of understanding complex designs, such as mask or circuit layouts.

(m) Machine vision/Automated surveillance/Image fusion applications:

A dual view display may be used for machine vision or automated surveillance by replacing two separate displays. A dual view display may be used for image fusion by allowing hands-free switching by the user between a view showing, for example, infra red data and a view showing visible data. The switching is performed by the user moving their head and moving from one viewing window to another viewing window.

(n) Multiple views for mobile devices:

For a mobile display device a dual or multi-view display may be used so that private information such as an e-mail is viewed in the on axis view and non-private information in an off-axis view or views. The distribution of the views may be asymmetric. An accelerometer may be used to detect the motion of the user tilting the display to automatically update or switch the views. This may be useful for a mobile (“cellular”) telephone or a personal digital assistant (PDA). Alternatively, a multiple view display 20 may be used for a mobile display 44 which displays GPS information. The display may be tilted right 45, left 46, up 47 and down 48 to reveal the corresponding east, west, north and south GPS information or views 49 to 52, respectively. This is illustrated in FIG. 10.

### 3. Entertainment

(a) Dual view karaoke:

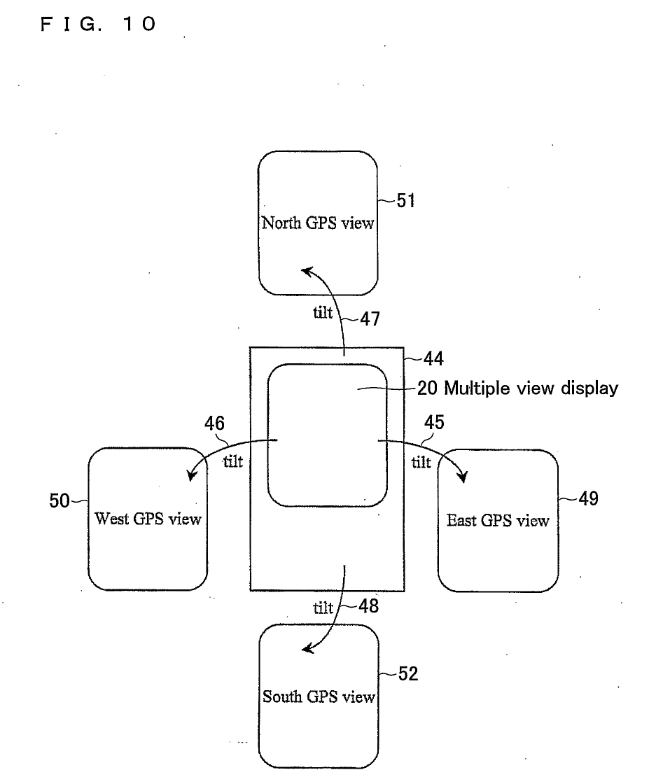

A dual view display may be used for karaoke. Different words are displayed in different directions 6 and 7 to different singers 53 and 54, respectively, from one display enabling singing of duets. This reduces the number of screens needed and hence costs. This is illustrated in FIG. 11. The display may also be switchable to a wide mode of operation enabling all singers 53, 54 to see the same words.

(b) Planes

A multiple view display 20 may be used in aeroplanes for in flight entertainment. A single screen is used to display the different in flight entertainment choices of multiple passengers to their respective seats. This reduces the number of screens required and hence reduces costs. In the example is illustrated in FIG. 12, the views for passengers 55-57 in the left, middle and right seats of a bank of aeroplane seats are directed by the display 20 in directions 21 to 23, respectively.

(c) Child friendly versions of films/TV:

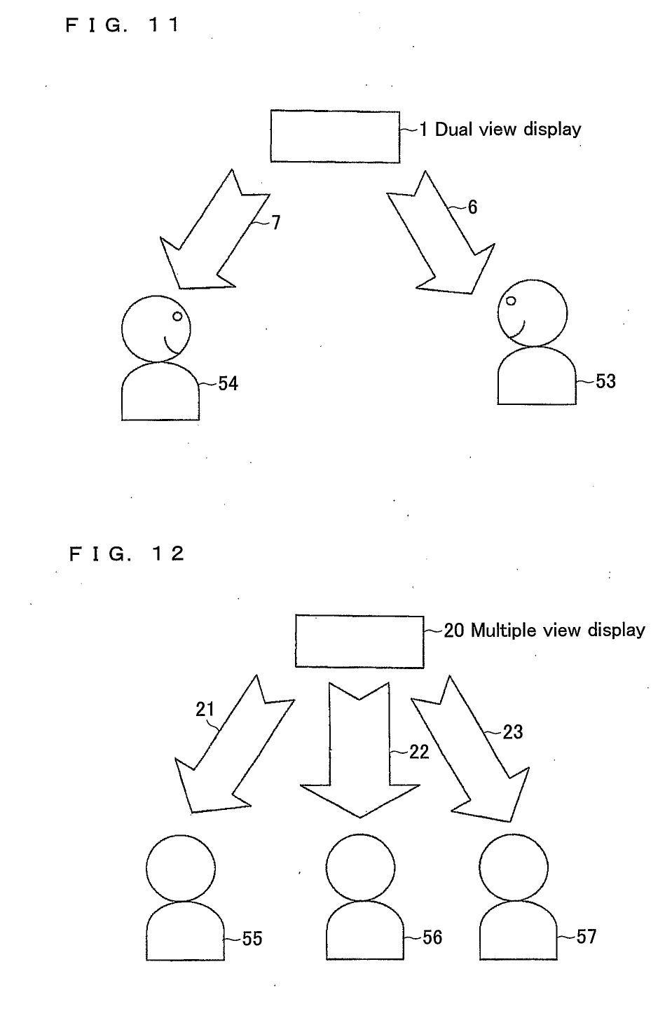

A dual view display 1 may be used to display one image to a child 59 in a direction 7 and a second to an adult 58 in a direction 6, as illustrated in FIG. 13. This may be used to display a child friendly version of a film or TV programme and one suitable for an adult separately.

(d) Dual view TV:

A dual view display may be used so that multiple viewers may simultaneously watch multiple TV channels or films from one display. Directional sound or headphones may also be used. Alternatively one or more of the viewers may wish to view a text service or e-mail or to play a game.

(e) Dual 3D:

A dual view display may be used to display a different three dimensional image to each view for example an autostereoscopic image produced by means of a parallax barrier. An example of the use of such a display is to allow 3D chess to be played.

(f) Sports matches:

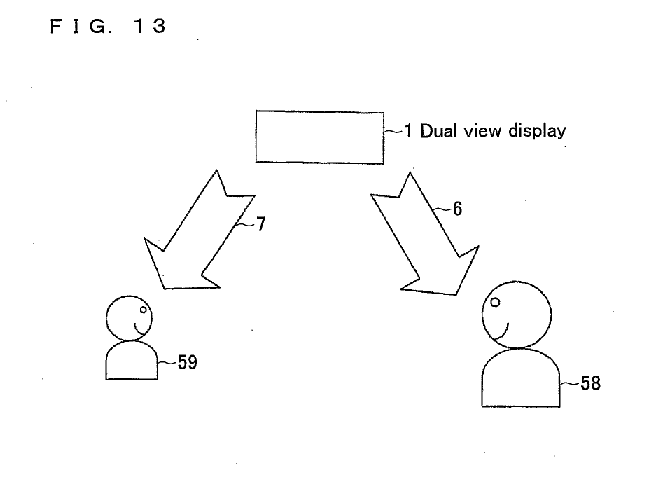

A multiple view display 20 may be used at sports matches. For example, during a cricket match as illustrated in FIG. 14(a), it may be used as a sightscreen; no image or a white background may be displayed as illustrated at 59 straight on for the batsman 60 whereas, to the views off to either side as illustrated at 61 and 62, replays or scores or similar may be displayed to the spectators. Alternatively, at football matches as illustrated in FIG. 14(b), a multiple dual view display 20 may be used to present different replays to the home team spectators as illustrated at 63 and to away team spectators as illustrated at 64. The match score may be visible in a direction 65 with the display 20 disposed above one of the goal nets 66. The display may be of an LED type.

(g) Portable DVD player:

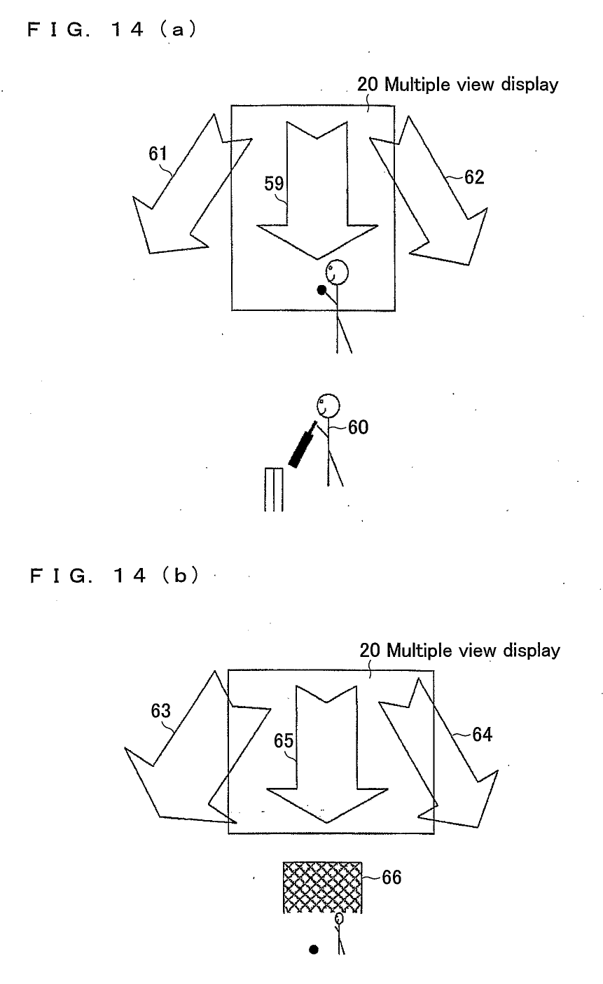

A dual view display 1 may be used for a portable DVD player. The dual view display has a touch screen on it's front surface. Control buttons 70 are generated as additions to the DVD image for one view as shown in FIG. 15(b) so that the user 67 may access the DVD player controls 70 but be absent from the other view shown in FIG. 15(a) so that the DVD may be viewed at full resolution. The Dual view display may be simply tilted between tilt angles 68 and 69 to toggle between the two views.

(h) Computer games:

A dual view or multi-view display may be used for computer games involving multiple players. This is particularly beneficial for games where not being able to see the view of the or each other player of the game is advantageous.

(i) Motion images:

A dual view display may be used to present motion images to the viewer by presenting one image to one view and a second image to a second view in which the action has slightly progressed. By the viewer moving from one viewing window to the next quickly, the viewer perceives a motion in the image, for example, by rotating the display backwards and forwards through a small angle to move from one view to the next. There may be a motion detector which automatically detects the motion and updates the other view with the next frame of the motion clip.

### 4. For Privacy

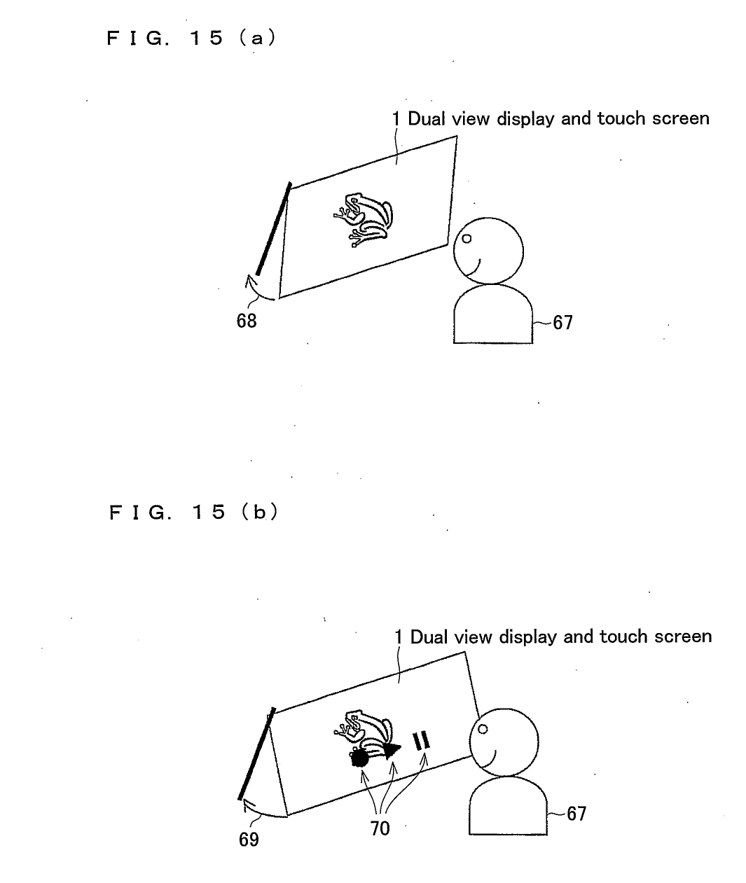

A dual view display may be used as a privacy device for situations such as banking where existing privacy devices are already in use. In this case, one view presents, for example, a summary of the account details for the customer 71 whereas the other view presents a screen for entering security information for the bank staff 72. The views are directed in the directions 6 and 7 towards the bank staff and customer as is illustrated in FIG. 16.

### 5. Dual View Virtual Keyboard

A dual view display 1 may be used with a mirror 73 to give the appearance of a virtual keyboard. As shown in FIG. 17, the display 1 may be part of a tablet personal computer (PC) or of any other electronic apparatus requiring the display of or interaction with a keyboard function.

The display 1 directs a first view towards a user of the apparatus, for example who views the display 1 from within an angular range including the normal to the display surface. The apparatus also includes the mirror 73 and the display 1 directs a second view towards the mirror 73 so that it is reflected in order to be visible to the user. The second view contains an image forming a virtual keyboard 74.

In order to permit interaction with the keyboard such that the user may use the virtual keyboard 74 in a similar way to a “physical” keyboard for making entries to the apparatus, a detection system 75 is provided. The detection system 75 may comprise an optical detection system and is arranged to determine which key of the virtual keyboard 74 the user intends to press. This may then be signalled to the apparatus, which responds in the same way as though an actual key of a physical keyboard had been pressed.

### 6. Interaction with Dual View Displays

(a) Dual view remote control:

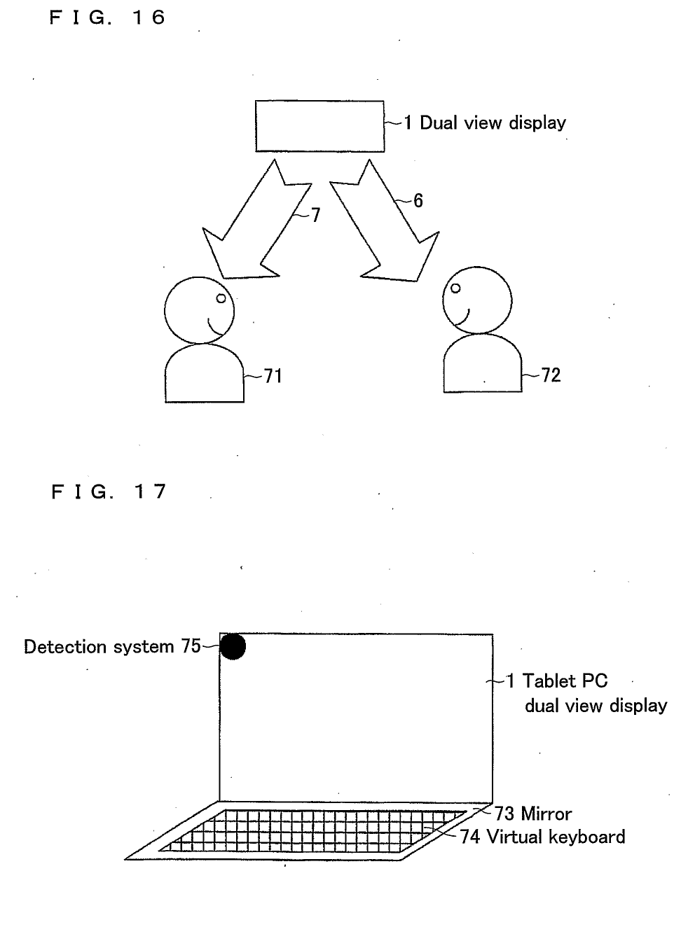

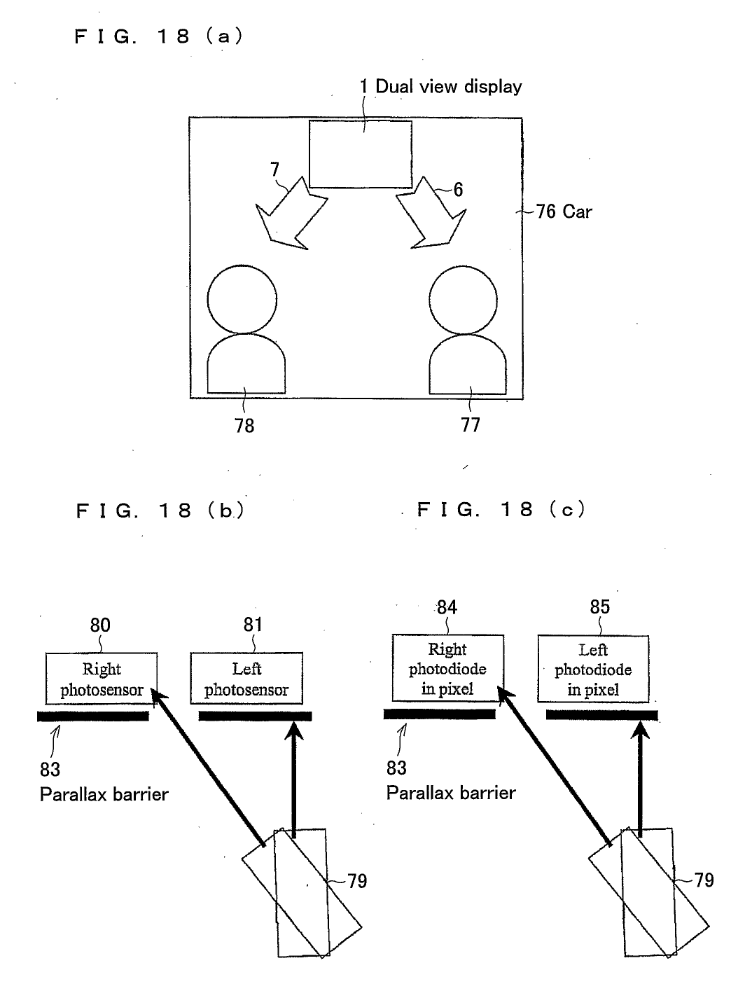

A dual view display 1 may be roof mounted for the rear seat passengers 77, 78 of a car 76 as shown in FIG. 18(a). There may only be one remote display control device 79 (FIGS. 18(b) and 18(c)) which will control the functionality of each view. For example, one passenger 76 may be watching a DVD and may wish to pause the film, whereas another may be playing a computer game and may want to restart the game.

FIGS. 18(b) and 18(c) show an apparatus including a directional detector system. In a first embodiment shown in FIG. 18(b), two photosensors 80 and 81 (or an array of two sorts of photosensors) are placed behind the parallax barrier 83 or other optic of the display 1 in appropriate positions. The parallax optic prevents the signal from the remote display control device 79 from the left passenger 78 from reaching the right passenger's photosensor 80 and vice versa.

In a second embodiment as illustrated in FIG. 18(c), photodiodes 84, 85 may be introduced into some of the pixels in the LCD display panel of the display 1. The parallax optic 83 again prevents the signal from the remote display control device 79 from the left passenger 78 from reaching the pixels containing the right passenger's photodiode 84 and vice versa. This may also be used in the home or other situations where a dual or multiple view display may be used to display two or more independent views, for example, in a living room for different TV channels. An alternative is that multiple remote controls are available—one for each view, each using a slightly different frequency or code signal so that the display can recognise which view to update. This may be particularly advantageous for computer games, for example in arcades where it is important to know which player fired which shot during the game.

(b) Dual view independent control:

When a dual view display 1 is being used to display a different function to each view, as illustrated in FIG. 19, there is a need to detect which user is trying to update their view and so show the appropriate options. This may be achieved by positioning photodetectors 86 and 87 on the left and right sides or edges of the display panel forming the display 1. Movement from the viewer, for example of the viewer's hand on the right side of the display as illustrated at 89, is picked up by the photodetector 87 on the right side and enables the menus for the right viewer to be displayed or the view updated, and similarly for the left viewer as illustrated at 88.

For in car use, the user interface for the driver's side could be restricted to very simple operation. For example, in daylight usage, the hand might reduce the light output from the display. For night-time usage, the hand might increase the light output from the display. It is also possible that, by detecting the length of time that the hand covers the detector, the extent of the variation could be controlled. Other features such as music volume could alternatively be controlled in a similar manner. The electronics could be set up with a suitable time constant and differentiating criterion. Comparisons with the signals from both detectors could also be established to remove the effect of common variations due to ambient illumination changes.

(c) A touch panel (which may be attached to a display) detects touch input from users. Optical sensors determine which of a number of users is touching the screen:

They may be:
imaging light sensors (such as CMOS or CCD sensors), or
individual photodiodes or light-dependent resistors or other light-sensing components, or
grouped light-sensing components

The term ‘light’ as used herein may mean visible, UV (ultraviolet) or IR (infrared) radiation.

Configuration 1: Individual Light Sensors

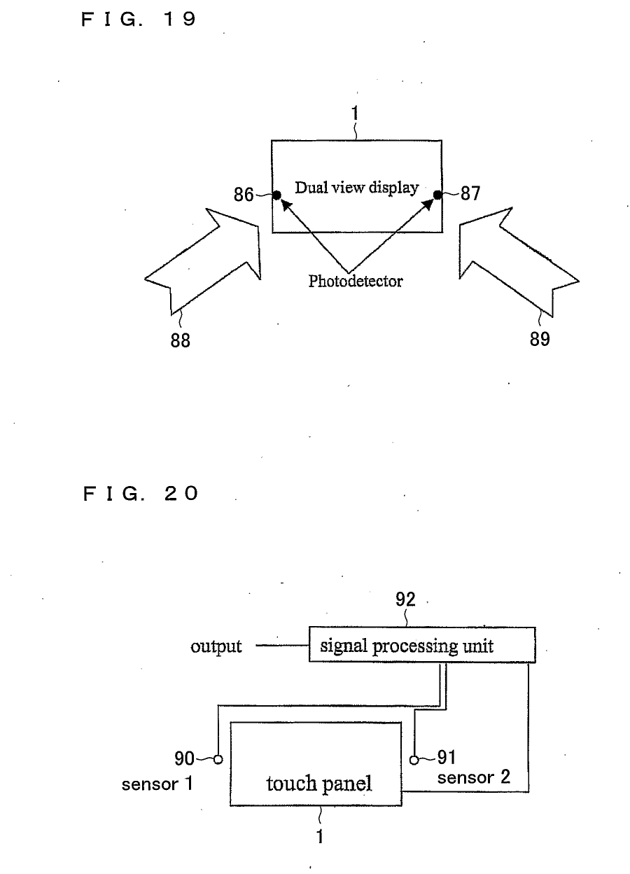

1. Two non-imaging sensors 90, 91 are used with a touch panel 1 which is used by one user on the left and another on the right (as in, for example, a central console display in a car equipped with a touch screen). This is illustrated in FIG. 20.

Sensor 1 and sensor 2 may be (but are not limited to):
Passive infra-red sensor as used in security systems
Photodiodes
Light-dependent resistors
Infra-red distance sensors (for example, those marketed by the Sharp Corporation as the GP2 series of general purpose distance measuring sensors).

The signal processing unit 92 performs the functions ordinarily associated with a touch panel and also processes signals from the sensors 90, 91 to determine which user is touching the panel. For example, the signal processing unit 92 may simply compare the light intensity sensed by two photodiodes 90, 91 and infer that the touch input comes from the side which has lower light intensity. Alternatively, the signal processing unit 92 may use a time-dependent method where the photodiode whose light intensity has decreased by the largest amount over a period preceding touch input is assumed to be on the side from which the touch input comes. Alternatively, the distance sensing output from distance sensors 90, 91 may be compared, with the side providing the shortest sensing distance inferred to be the source of the touch.

Configuration 2: Grouped Light Sensors

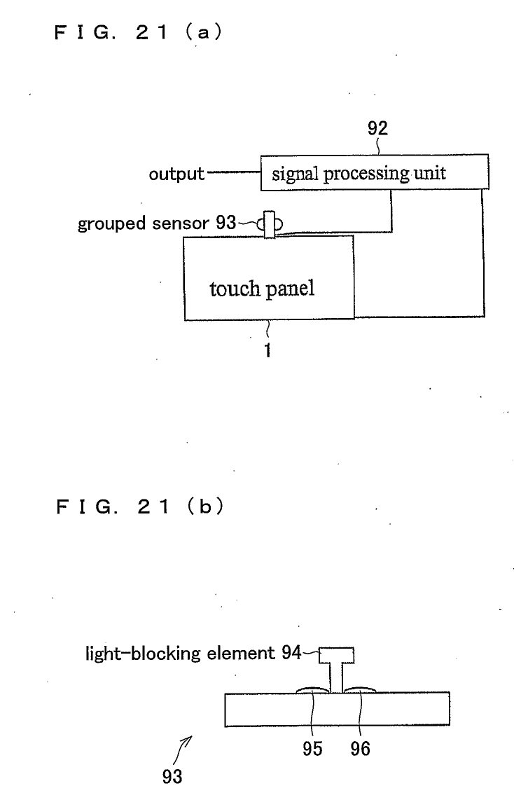

In the second configuration, illustrated in FIGS. 21(a) and 21(b), a group 93 of light sensors 95, 96 is juxtaposed with light-blocking elements 94 so that one photodiode 95 is sensitive to changes in light levels to the left of the panel 1 while another 96 is sensitive to changes from the right. The source of touch input may be determined using methods similar to the ones mentioned for configuration 1.

Configuration 3: Imaging Sensor

In configuration 3, a camera (comprising an imaging sensor together with a lens) is used to detect which direction the touch input comes from. Images from the camera are used by a microprocessor to infer the source of a touch input.

Configuration 4: In-Panel Image Sensor

It is now possible to integrate optical sensors into the display panel itself at a sub-pixel level. Using these sensors it is possible to measure the light falling across the panel. When someone touches the panel a shadow of their finger will fall across the display. The shape of this shadow can be used to determine the direction from which the finger arrives and thus which user is operating the panel.

Various sensor systems may be used in such an arrangement, for example those disclosed in “Continuous grain silicon pin diode” and “A low temperature polysilicon pin diode” (N. Tada et al, IDW '04, pp. 349, 2004 and T. Nakamura et al, SID 05 Digest, pp. 1054, 2005). Both publications disclose a liquid crystal device having a respective low temperature polysilicon pin diode integrated at each pixel and acting as a photosensor. Such an arrangement may be combined with suitable image processing techniques to provide finger image detection.

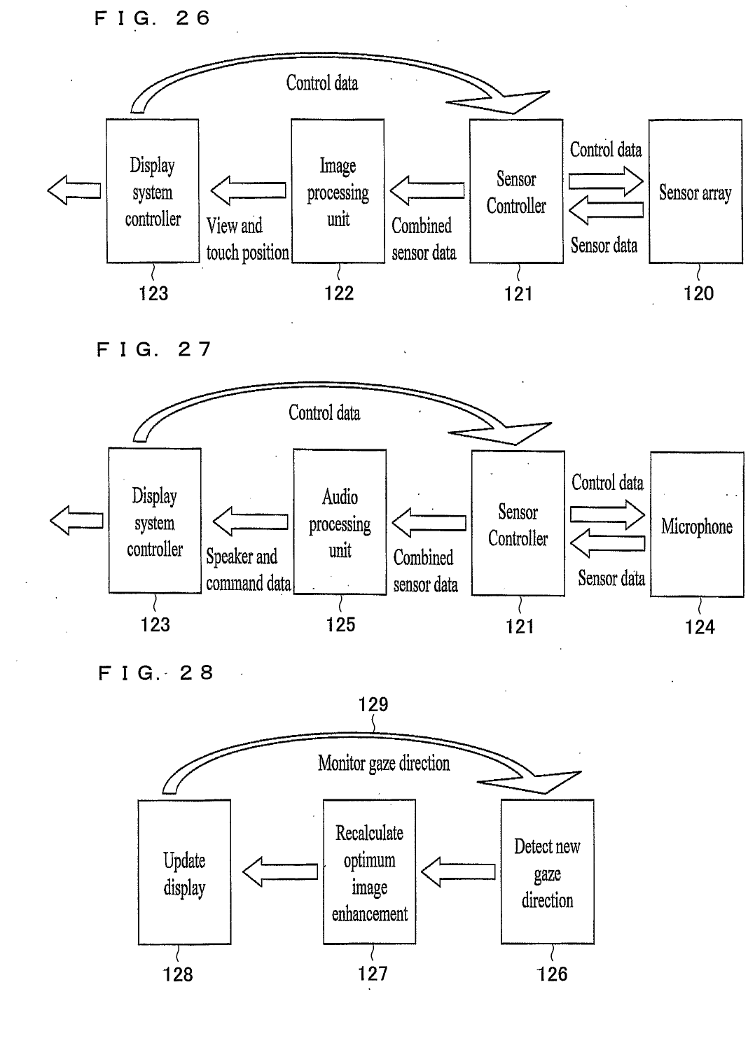

FIG. 26 illustrates an example of a system for providing finger image detection. An optical sensor array 120, which is integrated in the display panel and provides a sensor at each pixel, receives control data from a sensor controller 121, to which it transmits sensor data. The sensor controller 121 transmits combined sensor data from each sensor in the array 120 to an image processing unit 122. The image processing unit 122 performs image processing to detect the shadow of a finger falling across the display panel.

The extent, shape, depth and/or duration of the shadow of a finger, fingers, a hand or the like touching the display may be used to recognise the direction from which the touch arrives. For example, D. J. Tulbert, SID 05 Digest, pp. 1222, 2005 discloses how image processing may be applied to different types of touch on a display panel and how they may be distinguished. Using this or any suitable technique, the image processing unit 122 determines which view corresponds to the direction of the touch and also determines where on the display the touch was made. The view and touch position data are then passed to a display system controller 123. The display system controller 123 then performs an update appropriate to the touch on the display panel in the detected position for the relevant view.

By way of example, when such a display system is installed in a vehicle such as a car, the display panel may display a left view to a passenger watching a DVD and a right view to a driver viewing navigation information. If the passenger touches the display in the bottom left hand corner of the display panel, the sensor array 120 detects the touch, the sensor controller 121 passes the combined sensor data to the image processing unit 122, and the image processing unit 122 determines that the touch came from the left side of the display panel and was made in the bottom left hand corner of the display panel. The display controller 123 then performs an action appropriate for such a touch, for example by causing a menu relating to the DVD operation to be displayed by the display panel. If the touch is determined to come from the right hand side of the display panel, then the display controller 123 performs an appropriate action in relation to the navigation information. For example, this may allow the driver to control zooming on a displayed navigation map. Alternatively, the action resulting from the touch need not relate directly to updating of the display screen. For example, the action may relate to an accompanying sound.

(d) Automatic tracking of viewers:

A tracking system may be used to automatically detect when and which of the viewing windows are occupied and the viewing windows may then be updated accordingly.

(e) Voice control for dual view:

Voice control may be used to control the functions of a dual view display. Automatic detection of which user's is voice controlling the display enables the correct view to be updated. This is particularly beneficial for in car situations.

For example, JP 8044388 discloses an arrangement which can determine whether or not a voice has previously been recognised. Also various systems for performing speaker recognition are disclosed at HTTP://www.nist.gov/speech/tests/spk and HTTP://svr-www.eng.cam.ac.uk/comp/speech/Section6/Q6.6.html.

FIG. 27 illustrates a system for providing voice recognition including a microphone 124 connected to the sensor controller 121. The sensor controller 121 transmits an audio stream data from the microphone 124 to an audio processing unit 125, which performs speaker recognition to determine which of the viewers gave a command, for example to update the display. In particular, the audio processing unit 125 determines which view to update and which command was given. The view and command data are then passed to the display system controller 123. The display system controller 123 performs an update appropriate to the command for the display panel for the appropriate view.

For example, when the display system is installed in a car as described above, the passenger may say “pause DVD”. The audio processing unit 125 determines that the command was made in the voice of the passenger and that it is a command to, pause DVD play. The display system controller 123 pauses playing of the DVD for the displayed image in the direction of the passenger. If the driver says “zoom map” the display system controller 123 may then respond to this by zooming on the navigation map displayed in the view which is visible to the driver.

(f) In car system: A multiple view display may be used in a car with the driver seeing one view, for example navigation information, from a first head position and then by a small change in head position being able to move to see a second view containing for example the radio controls. There may be an additional view or views for the passengers. Alternatively the full panel resolution may be available for the driver's views. For example, the display may have a single (full resolution) view, possibly wide angle, mode of operation which may be selected by the driver (and possibly by one or more other users).

### 7. Angular/Height Image Segregation

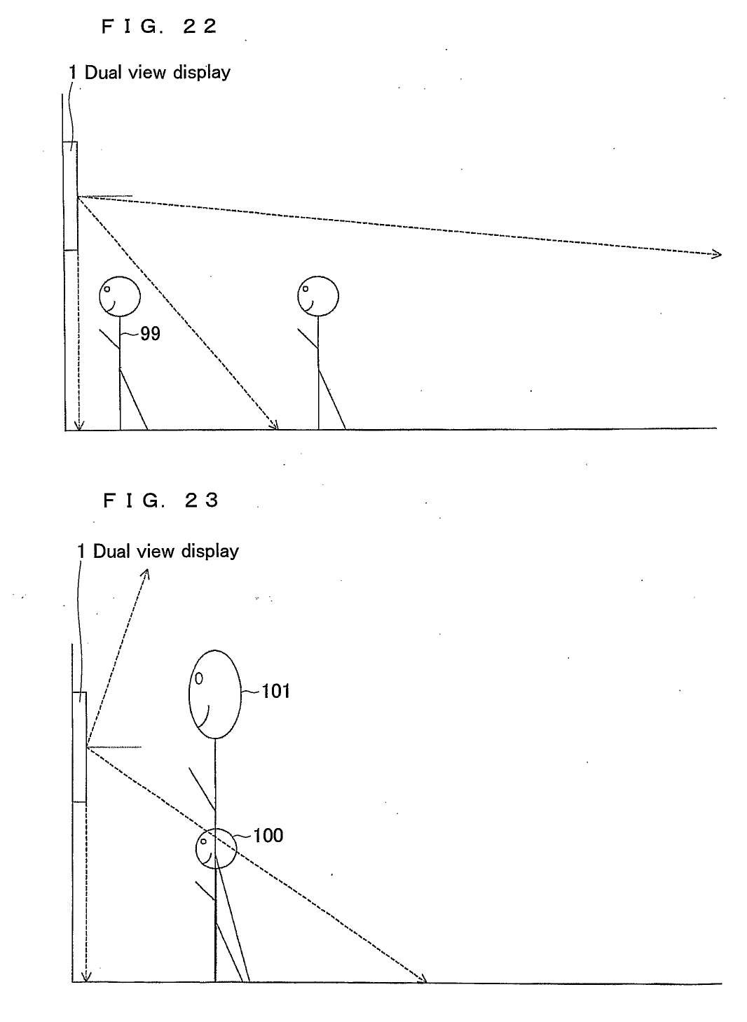

Dual view displays 1 may also be used to provide vertical image separation. FIG. 22 shows two viewing windows 97 and 98. One viewing window 97 is accessible only when a person 99 is close to the display 1. The other viewing window 98 is accessible further away from the display. The viewing windows may be symmetric or preferentially asymmetric. Techniques for allowing displays to produce asymmetric viewing windows are disclosed in GB 2405546. Alternatively, the dual view display 1 can be used to display one image in window 97 to a child 100 and a second in window 98 to an adult 101, or one image when a person is standing, and another when they are seated. This is illustrated in FIG. 23.

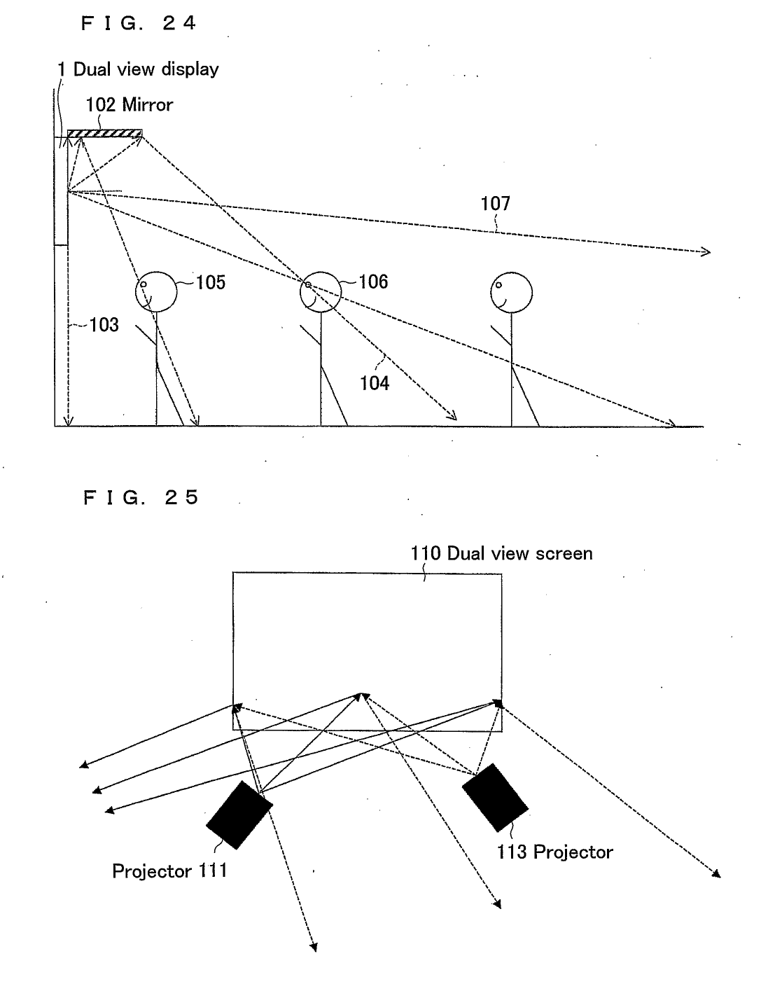

Alternatively, the dual view display 1 may be used together with a mirror 102 as shown in FIG. 24 so that, for a viewing region 97 (generally defined between broken lines 103 and 104) close to the display, the person such as 105 or 106 sees the dual view display 1 extended by the reflected image from the mirror 102 whereas, further away from the dual view display in a region 98 (generally defined by broken lines 104 and 107), the extended image reduces until it is no longer visible. A second image may be displayed in this viewing region by control of the angle and size of the mirror 102 and by control of the asymmetry of the viewing windows 97, 98.

Asymmetric windows 97, 98 may be generated, for example, by a parallax optic, such as a parallax barrier system. The centre of the parallax barrier opening is usually oriented with respect to the pixels which form each image such that it is substantially centered. Thus as you move from the normal to the display to one side, you see a certain amount of one pixel and, as you move from the normal to the display to the other side, you see the same amount of the other pixel. Viewpoint correction is then applied, which is a well known technique, and allows the formation of symmetric viewing windows.

If the parallax barrier opening is substantially offset from being centered over the pixels which form each image, then as you move from the normal to the display to one side, you see a certain amount of one pixel but, as you move from the normal to the display to the other side, you see a different amount of the other pixel. When viewpoint correction is then applied, instead of the formation of symmetric viewing windows, asymmetric viewing windows 97, 98 result. The benefit of using asymmetric viewing window in this way is that the angular range of the different viewing windows 97, 98 can tuned to meet the requirements of the different angular ranges illustrated in FIGS. 22, 23 and 24.

The above height and position techniques may be used in but are not limited to the following situations:

(a) Meeting room display:

A dual view display may be used for a display on a meeting room door. In the viewing zone far away from the display, simple information such as busy/free and the time at which the room is next free may be visible. However as the user gets closer to the door and enters the viewing zone closer to the display, more detailed information such as the time-table covering the use of the room may become visible.

(b) Appliances:

A dual view display may be used to display information for appliances such as printers and photocopiers and also for home appliances such as washing machines and dishwashers. In the viewing zone far away from the display, simple information such as busy or out of order or the time at which the program will complete may be visible. However as the user gets closer to the display and enters the viewing zone closer to the display, more detailed information such as the user options covering the use of the appliance may become visible.

(c) Public display:

A dual view display may be used for a display of public information such as on a railway station. In the viewing zone far away from the display simple information such as destination and the time of the next train may be visible. However as the user gets closer to the display and enters the viewing zone closer to the display, more detailed information such as the time-table and stops may become visible.

(d) Entry check for height restricted area:

A dual view display as illustrated in FIG. 23 may be used to perform an entry check for height restricted areas, for example fairground rides. The display of FIG. 23 may be used to present an image containing a code to the upper view and another image to the lower view. People who are tall enough to see into the upper view can view the code and they then input the code into a device, for example through a keyboard which then provides them with access to the height restricted area. People who are not tall enough to view the code cannot gain access. The code may be varied from one person to the next to prevent abuse of the system. Alternatively, there may also be an incorrect code presented to the lower view which only provides access to the exit.

(e) Child friendly versions of films/TV:

A dual view display can be used to display one image to a child 100 and a second to an adult 101, as illustrated in FIG. 23. This may be used to display a child friendly version of a film or TV programme and one suitable for an adult separately.

(f) Advertising by height to children and adults:

A dual view display can be used to display one image to a child 100 and a second to an adult 101, as illustrated in FIG. 23. This may be used to display a child focussed advert to the child and an adult focussed advert separately.

### 8. Dual View Projection

A dual view projection system as shown in FIG. 25 may be used so that, during presentations, only the speaker sees the notes on the projection screen 110 while the rest of the audience only sees the presentation. A dual projector system with a projection screen 110 which has directional optics may be used. The projector 111 for the first view for the audience illuminates the screen from one angle resulting in one relatively wide viewing zone 112 from the projection screen 110. The projector 113 for the second view for the speaker illuminates the screen from a second angle resulting in a second relatively narrow viewing zone 114 from the projection screen 110.

### 9. Head Up Display

For in car use, a dual view panel may be used with additional optics which take the driver's view and reflect it off the windscreen so that it may be used as a head up display.

### 10. Tracking

Tracking the eyes of each user of a dual view display may be carried out so that the point that they are currently focussed on is found. The image at this point may then be enhanced relative to the surroundings.

A. C. Varchmin et al, “Lecture notes in computer science”, vol. 1371, pp. 245, 1998 discloses a technique by which the gaze direction of a person may be detected and tracked. K. Kubala et al, SID 98 Digest, pp. 415, 1998 discloses a technique by which the pixels of a display may be radially remapped to match the varying acuity of the eye across its field of view. Such techniques may be used as illustrated in FIG. 28.

In such a system, the gaze direction of a viewer is monitored continuously as illustrated at 129, for example using the technique mentioned above or any other suitable technique. A new gaze direction is detected at 126 and this is use at 127 to recalculate the optimum image enhancement, for example using the above technique or any other suitable technique. The display is updated at 128 and then the system returns to monitoring gaze direction until a new gaze direction is detected.

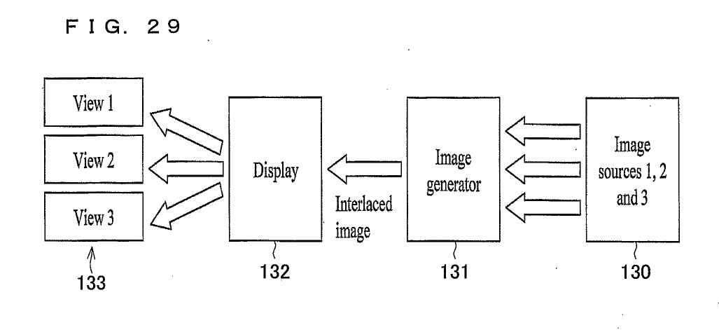

FIG. 29 illustrates an arrangement for providing image generation for use in any of the previously described arrangements. The role of an image generator 131 is to combine two or more data inputs representing images to be displayed in a manner such that they are correctly displayed by the display 132. The two or more image sources 130 may supply image data in the same or different formats. Examples of image sources include, but are not limited to, DVD players, CD players, mini disk players, USB key disks, hard drives, live feeds from camera systems, digitised photographs, navigation systems, digitised films and computer systems.

The image generator 131 may, for example, be based on the techniques disclosed in GB 2414882. The image generator 131 receives the image information from each image source (image source 1, 2, 3) 130 and, if necessary, rescales the data so that it is in an appropriate format for the display resolution and other display capabilities, for example, a number of grey levels. This is performed as necessary for each input. The images are then interlaced in a suitable manner for display by the display device 132. For example, the first column of pixels in the image displayed by the device 132 is taken from the rescaled input information for the first image source, the second column of pixel from the rescaled information for the second image source and so on for each of the image sources. This is then cyclically repeated so as to form the image displayed by the device 132 by spatially multiplexing the source images. The display device 132 is arranged to direct light from each image into a respective different viewing region (view 1, 2, 3) 133, for example, using parallax optic techniques or backlights of the appropriate type.

### INDUSTRIAL APPLICABILITY

A display system of the present invention may be used in any application where it is desirable for individual users to be able to see different information from the same display. For example, a display system of the invention may be used for educational purpose, business meeting, motor vehicle, or entertainment purpose, for two or more viewers or users.

1. An interactive multiple view display system comprising:
a multiple view display arranged to display images of independently selectable content which are visible in respective different viewing regions;
a detection arrangement arranged to detect which of a plurality of users is attempting to interact with at least one of the images by detecting the location or direction with respect to the display of the or each detected user from the depth and/or duration of a shadow cast by the or each user on the display; and
an interaction arrangement arranged to permit the or each detected user to interact with the or a respective one of the at least one image.

2. A system as claimed in claim 1, in which:
the detection arrangement is arranged to detect which of the users are simultaneously attempting to interact with the images.

3. A system as claimed in claim 2, in which:
the interaction arrangement is arranged to permit the users to interact simultaneously with respective ones of the images.

4. A system as claimed in claim 1, in which:
the detection arrangement comprises a light sensing arrangement attached to or forming part of the display.

5. An interactive multiple view display system comprising:
a multiple view display arranged to display images of independently selectable content which are visible in respective different viewing regions;
a detection arrangement arranged to detect which of a plurality of users is attempting to interact with at least one of the images and comprising a voice recognition system for determining the identity of the or each detected user; and
an interaction arrangement arranged to permit the or each detected user to interact with the or a respective one of the at least one image.

6. A system as claimed in claim 1, in which:
the interaction arrangement comprises a touchscreen forming part of the display and an image generator for generating as at least one of the images an image representing user-operable controls.

7. A system as claimed in claim 6, in which:
the image generator is arranged to generate an image of a keyboard or keypad.

8. A system as claimed in claim 1, having an alternative single view mode of operation which is selectable by at least one user.

9. A multiple view display system comprising:
a fixed-location multiple view display arranged to display images of independently selectable content which are visible in viewing regions at respective different heights with respect to and/or distances from the display and a mirror for increasing the display area in a viewing region nearest the display.

10. A system as claimed in claim 9, comprising an image generator for supplying to the display image data representing at least one image whose content is relevant to and/or determined by location of the viewing region in which the at least one image is visible.

11. A multiple view display system disposed adjacent a user-operable apparatus, comprising:
a fixed-location multiple view display arranged to display images of independently selectable content which are visible in viewing regions at respective different heights with respect to and/or distances from the display; and
an image generator for supplying to the display image data representing at least one image whose content is relevant to and/or determined by location of the viewing region in which the at least one image is visible, the image generator being arranged to supply to the display, for display in a viewing region adjacent the apparatus, image data representing information for user-interaction with the apparatus.

12. A multiple view display system comprising:
a fixed-location multiple view display arranged to display images of independently selectable content which are visible in viewing regions at respective different heights with respect to and/or distances from the display; and
an image generator for supplying to the display image data representing at least one image whose content is relevant to and/or determined by location of the viewing region in which the at least one image is visible, the image generator being arranged to supply to the display, for display in a viewing region above a predetermined height, image data representing an entry code for permitting entry to a restricted area.

13. A system as claimed in claim 9, 11 or 12, in which:
the display is arranged to generate asymmetric viewing windows.

14. A multiple view display system comprising:
a multiple view display arranged to display images of independently selectable content which are visible in respective different viewing regions; and
an image generator for supplying to the display image data representing different views of the same subject for display as different images.

15. A system as claimed in claim 14, in which:
the different views comprise at least one overlay view.

16. A system as claimed in claim 14, in which:
the different views comprise images captured in different parts of the electromagnetic spectrum.

17. An interactive multiple view display system comprising:
a multiple view display arranged to display images of independently selectable content which are visible in respective different viewing regions;
an image generator for supplying to the display image data representing different images including a graphical user interface which is visible in at least one of the viewing regions and is not visible in at least one other of the viewing regions; and
a detection arrangement for detecting user interaction with the graphical user interface, the image generator being arranged to supply image data representing an image or image sequence to be visible in the at least one other viewing region and the same image or image sequence overlaid by the graphical user interface to be visible in the at least one viewing region.

18. A system as claimed in claim 17, forming part of an apparatus arranged to respond to detected user interaction.

19. A multiple view display system comprising:
a multiple view display arranged to display images of independently selectable content which are visible in respective different viewing regions;
a tracking arrangement for determining at least one point on the display at which at least one user is looking; and
an enhancing arrangement for enhancing image display at the at least one point, relative to a surrounding region of the display, at least of the image visible to the at least one user.
